(19) United States
(12) Patent Application Publication
(10) Pub. No.: US 2008/0254244 A1
(43) Pub. Date: Oct. 16, 2008

(54) TEXTILE SLEEVE FOR PROTECTING ELONGATE MEMBERS AND METHOD OF CONSTRUCTION

(76) Inventors: Hiroki Yamaguchi, Kanagawa (JP); Koushiro Hashimoto, Hadano (JP)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/100,833

(22) Filed: Apr. 10, 2008

Related U.S. Application Data
(63) Continuation-in-part of application No. 11/734,049, filed on Apr. 11, 2007.

(51) Int. Cl. B32B 1/08; B32B 27/00

(52) U.S. Cl. 428/36.1; 428/34.1

(57) ABSTRACT

A textile sleeve for protecting elongate members and method of construction thereof provides a sleeve having a wall constructed at least in part from generally round monofilaments. The sleeve wall provides a central space extending along a longitudinal axis between opposite ends for receipt of the elongate members. The monofilaments have a region with a permanently melted and flattened outer surface adjacent at least one of the ends. The melted and flattened region provides an increased surface area to which tape can be adhered, while also acting to reduce the potential for end fray of the filaments forming the textile sleeve.

### CROSS-REFERENCE TO RELATED APPLICATION

This application is a continuation-in-part of U.S. patent application Ser. No. 11/734,049, filed Apr. 11, 2007, which is incorporated by reference herein in its entirety.

### BACKGROUND OF THE INVENTION

1. Field of the Invention

This invention relates generally to textile sleeves for protecting elongate members, and more particularly to textile sleeves having ends secured against relative axial movement to the elongate members.

2. Related Art

Protective sleeving is used throughout the automotive, industrial, marine, airline and aerospace industries to organize and protect elongate members, such as wiring harnesses and optical fiber cables, for example. The sleeving surrounds the elongate members and protects them against cuts, abrasion, radiant heat, vibration induced wear and other harsh environmental threats. When positioned within protective sleeving, the wiring or cables are also held together in a neat bundle, allowing a multiplicity of different items to be handled as a sub-assembly, thus saving time and effort during integration of the items into its end environment.

Protective sleeving may be made by weaving, braiding or knitting filaments into a textile substrate and then resiliently biasing the substrate into a tubular form to define a central space for receiving the elongate items. Biasing may be effected by heating the filaments when the substrate is wrapped about a cylindrical mandrel, wherein the filaments take on a permanent set conforming to the shape of the mandrel upon cooling. In addition, the filaments can also be resiliently biased into a curved shape by applying chemicals thereto, as well as by cold working.

When textile substrates are biased into a tubular shape via the mechanisms described above, monofilaments are typically oriented in the “hoop” or circumferential direction of the tube. Monofilaments provide excellent stiffness and provide strong resilient biasing that maintains the substrate in the tubular shape. The biased monofilaments also tend to restore the substrate to its tubular shape in the absence of a distorting force, which is generally applied when the sleeve is manipulated to an open state to insert or remove an elongate member.

In some applications, as shown in FIG. 5, upon a sleeve 110 having elongate members 122 disposed therein, it is necessary or desired to secure the sleeving 110 to the elongate member 122 to prevent relative axial movement between the elongate member 122 and the sleeving 110. Commonly, tape 124 is used to secure one or both ends of the sleeving 110 to the elongate member 122. The tape 124 is generally wrapped circumferentially about the assembly so that a portion of the tape 124 overlies and adheres to the end of the sleeving 110 while an opposite portion of the tape 124 overlies and adheres to the elongate member 122. Unfortunately, due to the sleeving being constructed at least in part from generally round monofilaments 130, the surface of the sleeving 110 to which the tape 124 is applied provides limited surface area for adhesion of the tape 124. The poor adhesion results largely due to the reduced surface area provided by the convex surfaces of the round filaments 130 forming the sleeving 110. As such, the tape 124 can become detached from the end of the sleeving 110, thus, allowing the sleeving 110 to move axially relative to the elongate member 122. This can result in unwanted exposure of the elongate member 122.

### SUMMARY OF THE INVENTION

The invention concerns a textile sleeve for protecting elongate members. The sleeve has a wall constructed at least in part from generally round monofilaments. The sleeve wall provides a central space extending along a longitudinal axis between opposite ends. The monofilaments having a region with a permanently melted and flattened outer surface adjacent at least one of the ends. The melted and flattened region provides an increased surface area to which tape can be adhered, while also acting to reduce the potential for end fray of the filaments forming the textile sleeve.

Another aspect of the invention includes a method of constructing a sleeve for protecting elongate members. The method includes interlacing filaments to form a textile substrate with at least some of said filaments being generally round monofilaments. Then, forming the substrate into a tubular shape having a central space extending along a longitudinal axis and plastically deforming a portion of the monofilaments to provide a flattened outer surface over a selected region of the substrate. Further, cutting the substrate into a desired length to form opposite ends of the sleeve with the flattened outer surface being adjacent at least one of the ends.

### BRIEF DESCRIPTION OF THE DRAWINGS

These and other aspects, features and advantages of the invention will become readily appreciated when considered in connection with the following detailed description of the presently preferred embodiments and best mode, appended claims and accompanying drawings, wherein:

FIG. 1 is a perspective view of a protective sleeve according to one presently preferred embodiment of the invention containing elongate members therein and being secured against relative axial movement to the elongate members;

FIG. 2 is schematic plan view of the protective sleeve shown in FIG. 1;

FIG. 3 is a cross-sectional view taken generally along the line 3-3 of FIG. 2 showing an end region of the sleeve with an adhesive tape applied thereto;

FIG. 4 is a cross-sectional view taken generally along the line 4-4 of FIG. 2 showing the end region and adhesive tape applied thereto;

FIG. 5 is a fragmentary cross-sectional view of a textile sleeve with an adhesive layer applied thereto according to the prior art;

FIG. 6 is a perspective view of a protective sleeve constructed in accordance with another presently preferred embodiment of the invention;

FIG. 7 is a plan view of an outer surface of the sleeve of FIG. 6 shown in an unwrapped state;

FIG. 8 is a plan view of an inner surface of the sleeve of FIG. 6 shown in an unwrapped state;

FIG. 9 is an end view looking in the direction of arrow 9 of FIG. 8;

FIG. 10 is a view similar to FIG. 8 illustrating a sleeve constructed in accordance with another presently preferred embodiment of the invention;

FIG. 11 is a perspective view of the protective sleeve of FIG. 10 shown curled about elongate members;

FIG. 12 is a schematic exploded perspective view of a forming base and ultrasonic horn used in construction of the sleeve of FIG. 6; and

FIG. 13 is a side view of the ultrasonic horn forming a weld region along the sleeve in accordance with one presently preferred embodiment.

### DETAILED DESCRIPTION OF PRESENTLY PREFERRED EMBODIMENTS

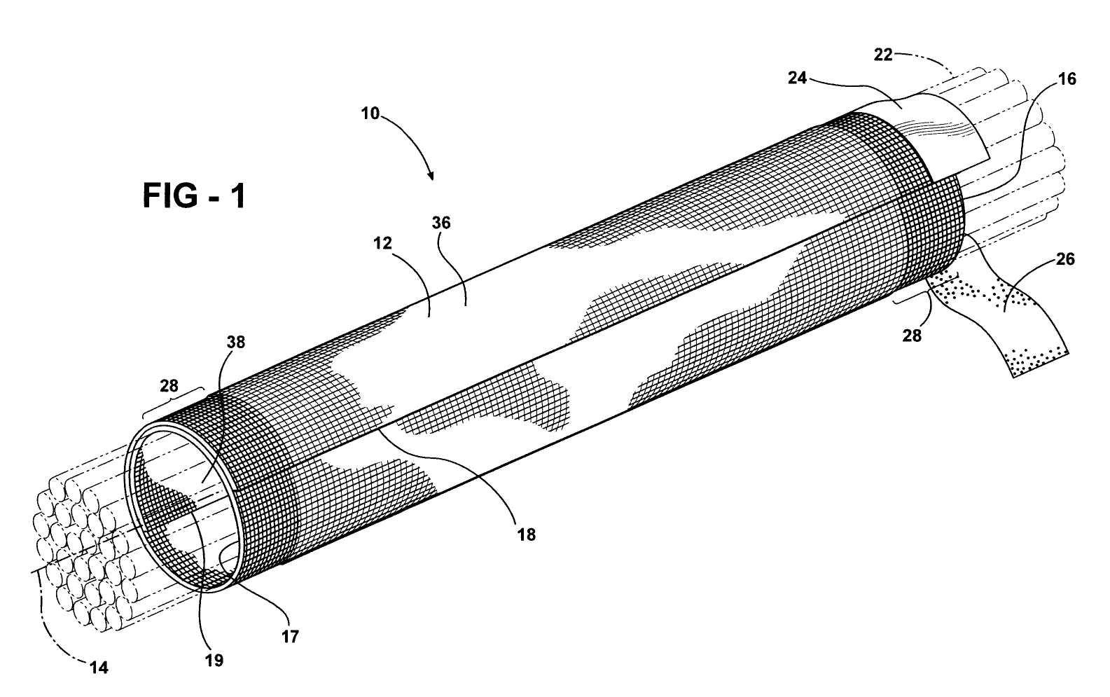

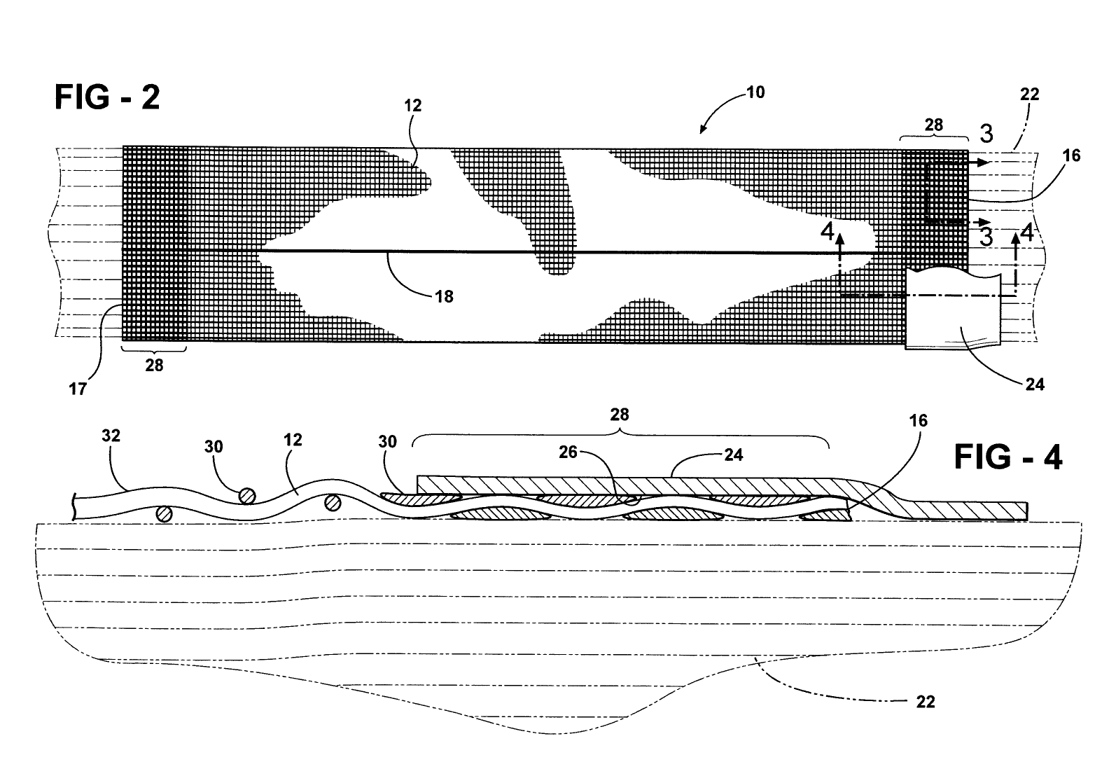

Referring in more detail to the drawings, FIGS. 1 and 2 illustrates a protective textile sleeve constructed in accordance with one presently preferred embodiment of the invention generally at 10. The sleeve 10 is constructed from an elongate textile substrate 12 that extends along a longitudinal axis 14 between opposite ends 16, 17. The substrate 12 can be knitted, braided, or woven, and has opposite selvages, referred to hereafter as free edges 18, 19 which either extend parallel to the axis 14 (the so-called “cigarette” wrap construction) or in a helical path (not shown) about the axis 14. In either case, the substrate 12 provides a central space 20 that receives elongate members 22 to be protected, such as a wiring harness or optical fibers, for example. The free edges 18, 19 are generally unbound, and thus, can be opened or spread apart from one another to allow the elongate members 22 to be disposed or removed from the central space 20, as desired. Upon inserting the elongate members 22 into the space 20, the free edges 18, 19 can be curled in overlapping relation to one another so that the elongate members 22 are fully encapsulated about their circumference. It should be recognized that the substrate 12 can be provided as a self-curling substrate, such that the edges 18, 19 are self-biased in overlapping relation, or they could otherwise be curled through an externally applied force. Upon enclosing the elongate members 22 within the substrate 12, a tape 24 having an adhesive surface 26, such as a pressure sensitive adhesive, for example, can be applied to overlap one or both of the ends 16, 17 of the substrate with the tape also adhering to the elongate members 22 to prevent the sleeve 10 from moving axially relative to the elongate members 22. A region 28 of the substrate 12 adjacent the end or ends 16, 17 to which the tape 24 is applied is prepared, as discussed in more detail hereafter, to promote adhesion of the tape 24 thereto so that the tape 24 does not readily detach therefrom in use.

The substrate 12 has a plurality of interlaced yarn filaments, wherein at least some of the filaments are monofilaments 30, while others can be provided as multifilaments 32, if desired for the intended application. For example, the yarns 30, 32 could be, depending on the performance requirements of the application, formed from, by way of example and without limitations, polyester, nylon, polypropylene, and polyethylene. It is to be recognized that this is by no means a comprehensive list of possible materials, and that other materials, including fire retardant materials, could be used.

As shown here, for example, the substrate 12 is woven at least in part with generally round monofilaments 30 extending in a weft or fill direction that is generally perpendicular to the longitudinal axis 14 of the sleeve, while multifilaments 32 are woven along a warp direction generally parallel to the axis 14. However, the monofilaments 30 could be interlaced along the warp direction in combination with, or in place of the multifilaments 32. The monofilaments 30 provide rigidity and hoop strength to the sleeve 10, and also allow it to be biased, such as in a heat-setting process, into a self-curled tubular shape. The monofilaments 30 extend over the length of the sleeve 10, and have outer surfaces 34 exposed to an outer periphery or surface 36 and an inner surface 38 of the sleeve 10.

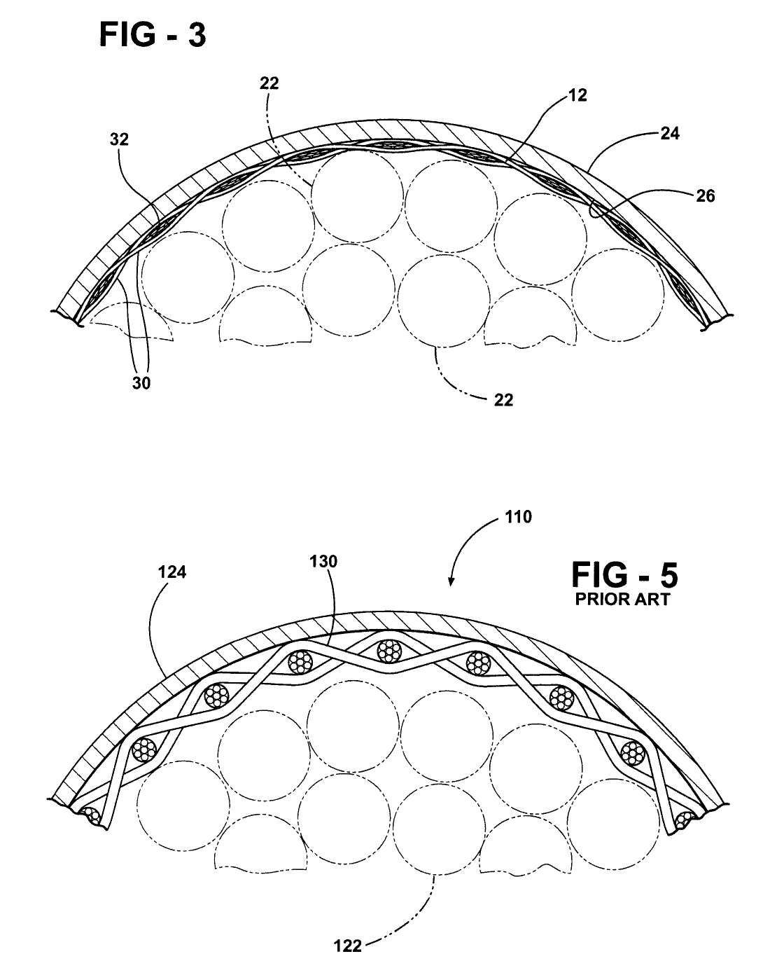

To facilitate bonding or adhering the tape 24 to the regions 28 adjacent the ends 16, 17 of the sleeve 10, the regions 28 are exposed to an ultrasonic welding process to flatten the outer surfaces 34 of the monofilaments 30 within the regions 28. The monofilaments 30 exposed to the ultrasonic welding are plastically deformed, and thus, at least partially melted so that the outer surfaces 34 flow to a permanently flattened configuration. As such, the outer surfaces 34 of the welded regions 28 remain substantially flattened, wherein the melted monofilaments 30 can flow at least partially over the multifilaments 32, if incorporated in the desired sleeve construction. The melted monofilament material flowing throughout the regions 28 provides a further function in addition to enhancing the adherence of the tape 24, in that it also acts to prevent a condition of end fray. End fray results, particularly with multifilaments, when the filaments adjacent the ends 16, 17 begin to unravel or separate from one another. With the melted material of the monofilaments 30 flowing throughout the regions 28, the potential for end fray is greatly reduced, and thus, the useful life of the sleeve 10 is increased. Accordingly, the melted regions 28 serve to provide a circumferentially flattened surface area on the outer surface and inner surfaces 36, 38, as best shown in FIGS. 3 and 4, to which the adhesive surface 26 of the tape 24 can bond, while also reducing end fray from occurring. It should be recognized that the multifilaments 32 shown could be replaced with the monofilaments 30 so that the sleeve 10 would be fabricated entirely of monofilaments, if desired. Further, it should be recognized that the portions of the monofilaments 30 not exposed to the ultrasonic welding, such as between the regions 28, remain unmelted and retain their generally round shape. Accordingly, the physical properties of the unwelded monofilament portions, such as strength, rigidity and resistance to abrasion, for example, are not altered.

In manufacture, the yarns of the substrate 12 are interlaced together, whether being woven, braided or knitted. As shown here, wherein the sleeve 10 is an open construction with opposite edges extending along the length of the sleeve, the substrate can be formed as a generally flat fabric, and then shaped, such as in a heat-setting process about a mandrel to take on its tubular shape. Upon being heat-set into the tubular shape, the overlapped edges 18, 19 are preferably opened slightly and out of contact with one another, and then the regions 28 extending at least partially, and shown here as extending completely across the width between the edges 18, 19 of the substrate 12 are exposed to the ultrasonic welding process to form the substantially flattened outer surfaces adjacent the ends 16, 17. Then, while still in the slightly opened state, the desired segment length of the sleeve is cut in a cutting operation, such as a hot-cutting process. By performing the ultrasonic welding and cutting operations with the substrate 12 in a partially opened configuration, the end regions 28 are prevented from being bonded in a permanently closed configuration. It should be understood that the desired length segments for the sleeve 10 could be cut first, and then the selected regions 18 could be ultrasonically welded, if desired.

The weld pressure, weld time and power settings used in the ultrasonic welding process will vary depending on the type and size of monofilament yarn used to construct the sleeve, as well as the size of the sleeve itself. It is important to recognize that the desired settings should avoid forming holes in the substrate 12, while being sufficient to provide the permanently flattened regions 28 to increase the adherence, and thus, peel strength of the tape 24 from the end regions 28 of the sleeve 10 once applied.

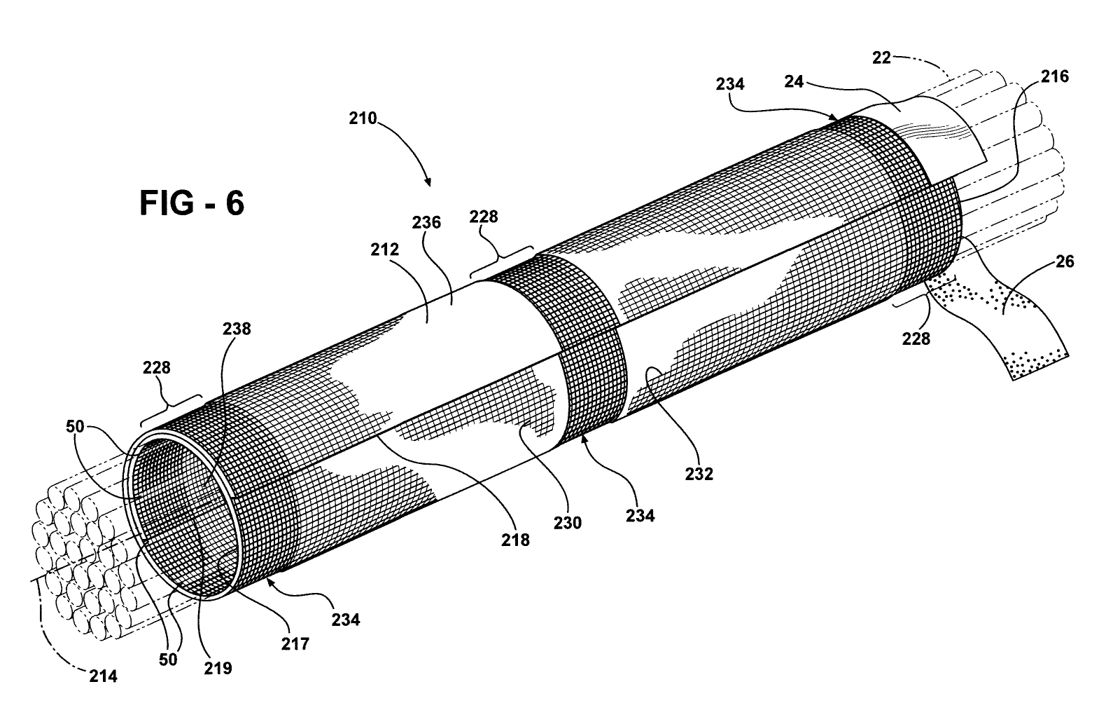

In FIG. 6, a sleeve 210 constructed in accordance with another aspect of the invention is illustrated. The sleeve 210 is constructed as an elongate textile substrate 212 and can be constructed using the same combinations of monofilament and multifilament yarns 230, 232 discussed above in association with the sleeve 10. Further, the sleeve 210 can be constructed using either a weaving, braiding or knitting process, and can also be heat-set to provide a self curling sleeve. In addition, the fabric of the sleeve 210 can remain in a generally flat state upon completing construction, wherein the fabric can be subsequently wrapped under an externally applied force to bring opposite free edges 218, 219 of the fabric into overlapping relation with one another to form the tubular sleeve 210. As described above, upon enclosing the elongate members 22 within the substrate 212, the tape 24 can be applied to overlap one or both of the ends 216, 217 of the substrate with the tape also adhering to the elongate members 22 to prevent the sleeve 10 from moving axially relative to the elongate members 22. As with the sleeve 10, regions 228 of the substrate 212 to which the tape 24 is applied are formed to promote adhesion of the tape 24 thereto so that the tape 24 does not readily detach therefrom in use. The regions 228 can be formed extending axially inwardly from one or both of the ends 216, 217 a predetermined distance sufficient to accommodate the width of the tape 24, and can be formed at one or more locations between the ends 216, 217, such that multiple ones of the regions 228 can be axially spaced from one another along the length of the sleeve 210 to facilitate maintaining the sleeve 210 is a completely closed and wrapped configuration with the tape 24.

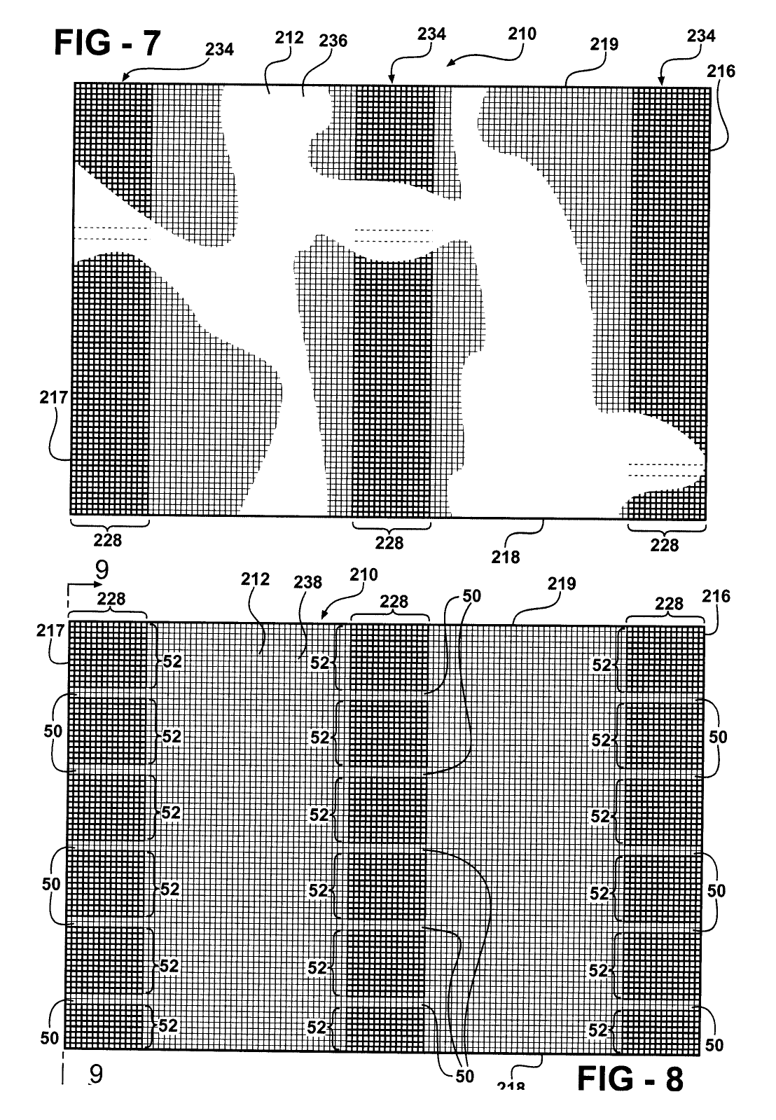

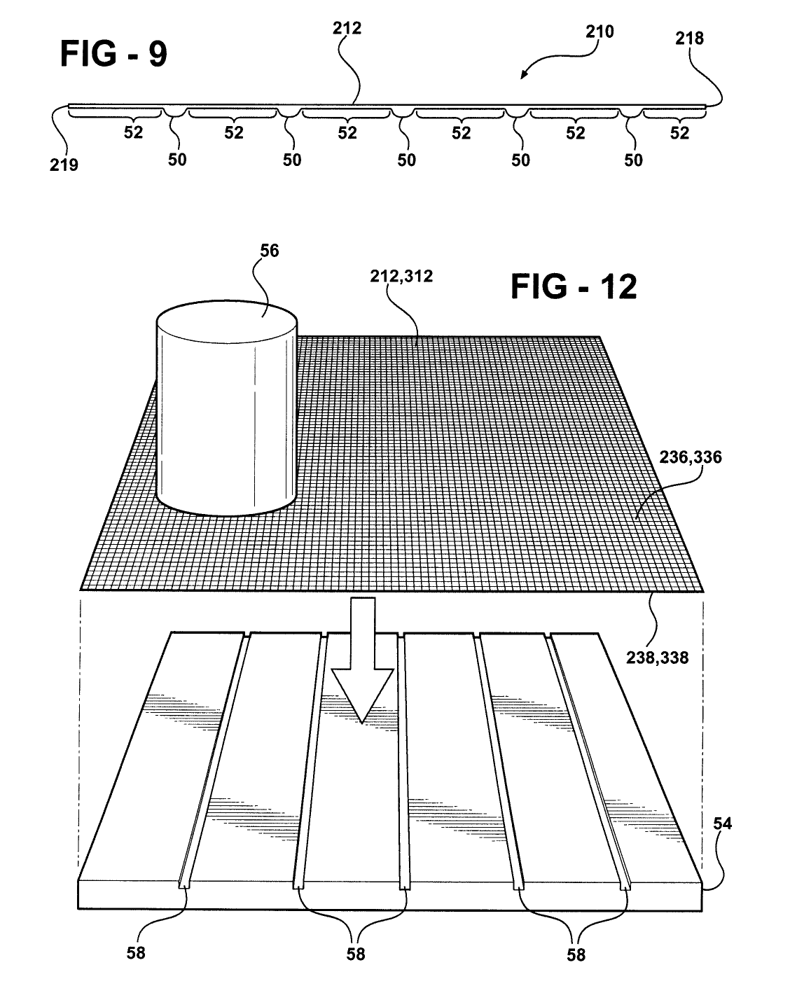

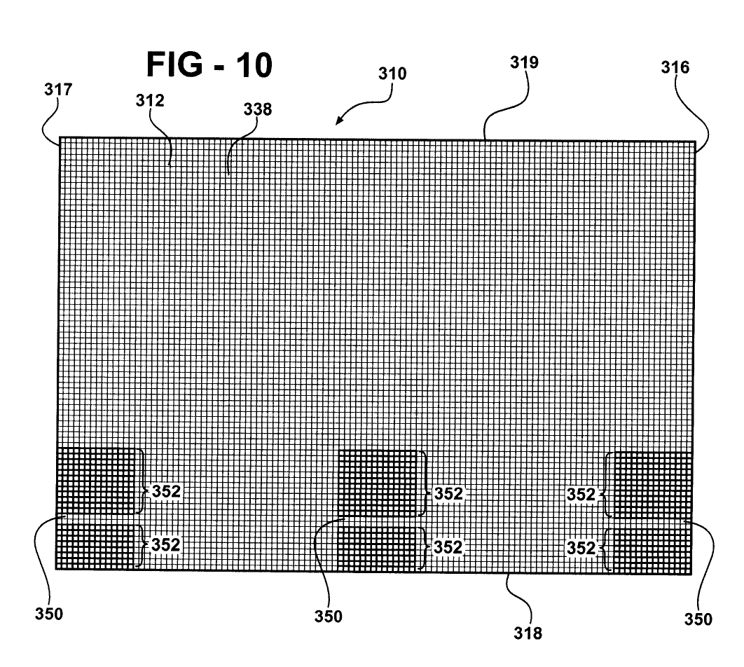

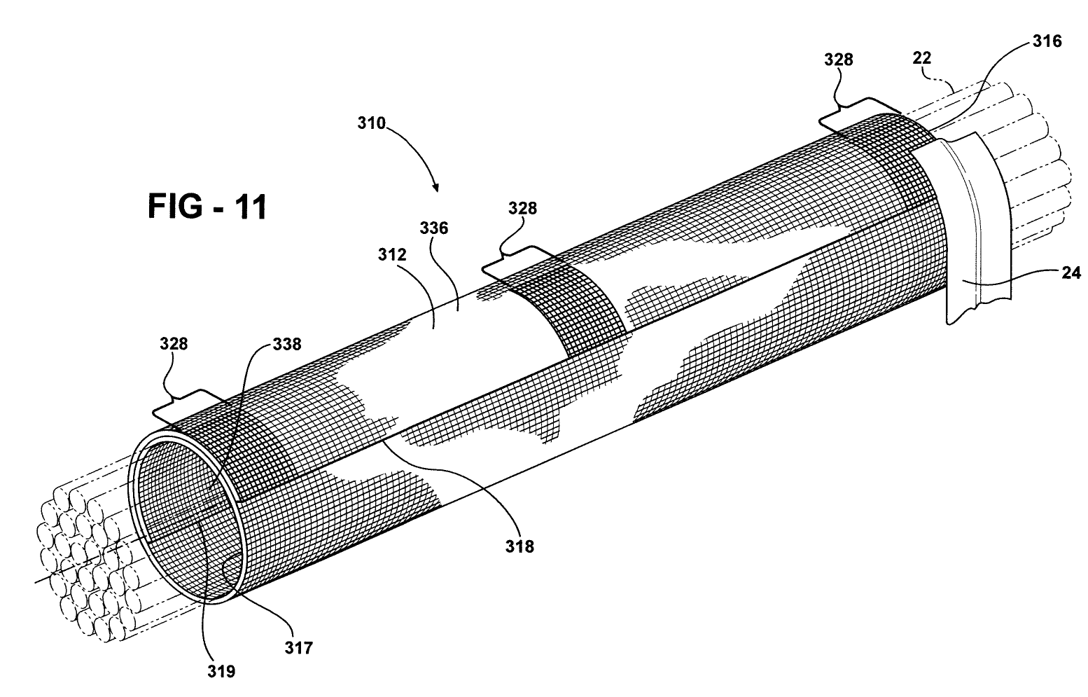

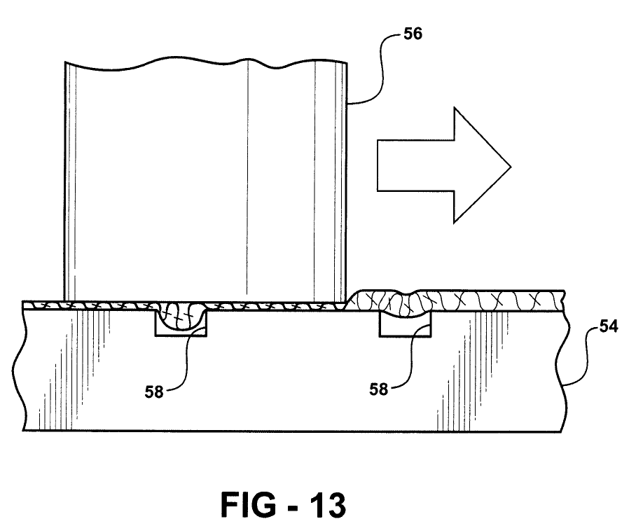

As shown in FIGS. 6-9, as with the sleeve 10 discussed above, the regions 228 to which the tape 24 is adhered are ultrasonically welded to at least partially melt and flatten the outer surfaces 234 of the monofilaments 230 within the regions 228. Accordingly, as shown in FIG. 7, the outer surface 236 of the sleeve 210 over which the regions 228 extend provide a substantially increased surface area to which the tape 24 can adhere from that of the non-welded regions. However, in contrast to the sleeve 10, as shown in FIGS. 6, 8 and 9, the welded regions 228 of the sleeve 210 have an inner surface 238 with circumferentially spaced bellows that are unwelded, unmelted portions of the monofilaments, referred to hereafter as ribs 50, extending along a longitudinal axis 214 (FIG. 6) of the sleeve 210 across the length of the respective welded region 228. As such, the substantially non-welded, radially inwardly extending ribs 50 (FIG. 9) provide the regions 228 with discrete, circumferentially spaced portions of welded sectors 52 along the inner surface 238 of the regions 228. Further, it should be recognized that the ribs 50, if welded regions 228 are formed at both ends 216, 217 of the sleeve and/or spaced axially inwardly from the ends 216, 217, can be formed in alignment with one another. Although the sectors 52 are shown here as being of generally the same size and shape extending between the opposite edges 218, 219, it should be recognized that the individual sectors 52 can be provided in any desired number about the circumference of the sleeve 210 by incorporating more or fewer ribs 50. For example, as shown in FIGS. 10 and 11, wherein a sleeve 310 constructed according to another presently preferred embodiment is illustrated, an elongate substrate 312 as discussed above has opposite edges 318, 319 extending between opposite ends 316, 317. However, rather than having welded sectors 52 extending entirely across the width of the substrate 312 between the opposite edges 318, 319, the sleeve 310 has a pair of welded sectors 352 extending inwardly from the edge 318 along the inner surface 338 with a single unwelded rib 350 separating each pair of sectors 352. Accordingly, the welded sectors 352 are free to flex about the ribs 350, as discussed below, when the substrate 312 is curled into its tubular form (FIG. 11), wherein the remaining portion of the unwelded substrate 312 remains as fabricated, without having welded sectors extending thereacross. As shown in FIG. 11, it should be recognized that the welded edge 318 remains in an outwardly overlapped relation to the edge 319, thereby exposing the welded regions 328 for attachment of an end of the tape 24 thereto. Upon bonding the end of the tape to the respective generally flat, welded section 328, the tape 24 is preferably wrapped circumferentially completely about the sleeve 310 wherein it can be bonded to itself to facilitate maintaining the tape 24 in secure attachment to the sleeve 310 and preferably the elongate members 22 extending therethrough. As such, the sleeve 310, having a reduced number of welded sectors 352, retains fully flexibility across its width over its unwelded region, is flexible across the ribs 350, and is generally more economical in manufacture than the sleeves 10, 210 with full welded regions 28, 228 across their entire width.

The ribs 50 provide the fabric with an increased ability to be formed into the desired tubular shape of the sleeve 210, and more specifically, provide the regions 228 with an increased ability to be formed into a tubular configuration. With the ribs 50 remaining substantially unwelded, the ribs 50 substantially retain the flexibility of the remaining portions of the unwelded fabric, thereby providing flexible joints between the adjacent, more rigid, welded sectors 52. The flexible joints can be aligned with one another over the length of the sleeve 210 to provide axially aligned living hinges between the adjacent sectors 52. Accordingly, regardless of whether the sleeve 210 is a self-curling or hand wrappable sleeve, the sleeve 210 is more readily able to be biased into its tubular configuration by being able to flex at the non-welded ribs 50. As such, the assembly of the sleeve 210 about the elongate members 22 is made easier, and the edge 218 is able to lye relatively flat in abutment with an underlying portion of the sleeve fabric. Accordingly, the edge 218 extending along the length of the sleeve 210 is kept from buckling or bowing outwardly, which would allow the potential ingress of fluid or other contamination.

As shown in FIG. 11, in manufacture, the fabric of the elongate substrates 212, 312 are first interlaced, such as by being woven, braided or knitted, into a desired size. Then the fabric is laid onto a forming base, referred to hereafter as bed 54, so that the side corresponding to the inner surface 238, 338 of the sleeve 210, 310 is in abutment with the bed 54. Then, an ultrasonic horn 56 is brought into welding contact with the other side of the fabric substrate corresponding to the outer surface 236, 336 of the sleeve 210, 310 to form the weld regions 228, 328 of a desired size, shape and location. The bed 54 has a plurality of recessed channels 58 extending along a direction corresponding to the axial length of the sleeve 210, 310. The channels 58 are formed having the desired depth, width and spacing from one another to form the desired configuration and arrangement of the ribs 50, 350. Although the bed 54 is illustrated having the channels 58 extending completely across its length, it should be recognized that the ribs 50 will only be formed on the surface of the fabric directly beneath ultrasonic horn 56, and thus, the ribs 50 are not necessarily formed across the full length, such as with the sleeve 310. Accordingly, the location of the ribs 50 can be controlled in part by manipulating the location on which the ultrasonic horn 56 abuts the fabric. Further, it should be recognized that with the construction of the sleeve 10, the bed 54 can be provided without the channels 58, thereby forming the continuous weld regions 28 across the desired portion between the edges 18, 19. As with the sleeve 310, it should be recognized that the weld regions 28 of the sleeve 10 can be formed extending from the edge 18 less than completely across the width of the substrate 12.

Obviously, many modifications and variations of the present invention are foreseeable in light of the above teachings. It is, therefore, to be understood that within the scope of the appended claims, the invention may be practiced otherwise than as specifically described for the presently preferred embodiments.

What is claimed is:

1. A textile sleeve for protecting elongate members, comprising:
a substrate constructed at least in part from generally round monofilaments, said substrate having an outer surface and an inner surface providing a central space extending along a longitudinal axis between opposite ends of said sleeve; and
a region of said monofilaments extending along said axis adjacent at least one of said ends being at least partially melted and permanently flattened on said outer surface, said permanently flattened monofilaments increasing a flattened outer surface area of said outer surface.

2. The textile sleeve of claim 1 wherein said permanently flattened region extends circumferentially about said outer surface of said substrate.

3. The textile sleeve of claim 1 wherein at least some of said monofilaments are woven in a fill direction generally perpendicular to said longitudinal axis.

4. The textile sleeve of claim 3 further comprising multifilaments woven in a warp direction generally parallel to said longitudinal axis.

5. The textile sleeve of claim 1 wherein said sleeve has opposite free edges extending along said longitudinal axis.

6. The textile sleeve of claim 5 wherein said free edges are biased to self curl in overlapping relation to one another.

7. The textile sleeve of claim 1 wherein a pair of said regions extend axially inwardly from both of said ends.

8. The textile sleeve of claim 7 wherein said monofilaments remain unmelted and generally round outside of said regions.

9. The textile sleeve of claim 7 wherein another one of said regions is formed between said pair of said regions, said another one of said regions being spaced axially from said pair of said regions.

10. The textile sleeve of claim 1 wherein a plurality of said regions of said at least partially melted and permanently flattened monofilaments are formed as separate regions circumferentially spaced from one another around said inner surface.

11. The textile sleeve of claim 10 wherein said separate regions are separated by unmelted portions of said monofilaments, said unmelted portions providing a living hinge extending parallel to said axis between adjacent ones of said separate regions.

12. A textile sleeve for protecting elongate members, comprising:
a substrate constructed at least in part from polymeric monofilaments, said substrate having an outer surface and an inner surface providing a central space extending along a longitudinal axis between opposite ends of said sleeve;
a region of said monofilaments adjacent at least one of said ends being at least partially melted and flattened on said outer surface to increase an outer flattened surface area of said outer surface; and
wherein said inner surface opposite and directly radially inwardly of said region has an axially extending portion of said monofilaments that remain substantially unwelded and unmelted to provide a flexible living hinge between adjacent melted sectors of said region.

13. The textile sleeve of claim 12 wherein said sleeve has overlapping axially extending free edges and said region is formed along at least a portion of one of said free edges.

14. The textile sleeve of claim 12 wherein said region extends completely circumferentially about said sleeve.

15. The textile sleeve of claim 14 wherein a plurality of said flexible living hinges are formed circumferentially about said region.

16. A method of constructing a sleeve for protecting elongate members, comprising:
interlacing filaments to form a textile substrate with at least some of said filaments being round monofilaments;
forming said substrate into a tubular shape having an outer surface and an inner surface providing a central space extending along a longitudinal axis;
melting a portion of said monofilaments over a selected are of said outer surface to provide a flattened region on said outer surface; and
cutting said substrate into a desired length to form opposite ends of said sleeve with said flattened outer surface being adjacent one of said ends.

17. The method of claim 16 wherein said melting step includes ultrasonically welding said monofilaments.

18. The method of claim 16 wherein said melting step includes forming flattened regions adjacent both of said ends.

19. The method of claim 16 wherein said interlacing step is performed by weaving.

20. The method of claim 19 further weaving said monofilaments in a fill direction generally perpendicular to said longitudinal axis.

21. The method of claim 16 wherein said forming step includes biasing said fabric into said tubular wall in a heat-setting process.

22. The method of claim 21 further including forming said tubular wall having overlapping edges extending along said longitudinal axis.

23. The method of claim 22 further including spreading said overlapping edges out of engagement with one another prior to said melting step.

24. The method of claim 22 further including spreading said overlapping edges out of engagement with one another prior to said cutting step.

25. The method of claim 16 further including providing said inner surface opposite and directly radially inwardly of said flattened region on said outer surface with substantially unwelded and unmelted axially extending portions to provide a flexible living hinge between adjacent melted sectors of said region.

26. The method of claim 16 further including forming said flattened region completely circumferentially about a portion of said outer surface sleeve.

27. The method of claim 25 further including providing a plurality of said flexible living hinges circumferentially about said inner surface opposite said flattened region.
